(19) United States
(12) Patent Application Publication
(10) Pub. No.: US 2019/0289431 A1
(43) Pub. Date: Sep. 19, 2019

(54) Method And Apparatus For Tracking Lost Devices In Mobile Communications

(71) Applicant: MediaTek Singapore Pte. Ltd., Singapore (SG)

(72) Inventor: Ravindra Kara, Bengaluru (IN)

(21) Appl. No.: 15/924,271

(22) Filed: Mar. 18, 2018

(51) Int. Cl. H04W 4/029; G08B 21/24; H04W 48/10

(52) U.S. Cl. CPC H04W 4/029; H04W 48/10; G08B 21/24

(57) ABSTRACT

Various solutions for tracking lost devices with respect to user equipment and network apparatus in mobile communications are described. An apparatus may camp in a limited service. The apparatus may transmit a message to a network node to report an identity of the apparatus. The apparatus may receive a response message from the network node. The apparatus may perform a location service (LCS) procedure initiated by the network node. The message may comprise a connect management (CM) service request message or an attach request message.

### TECHNICAL FIELD

The present disclosure is generally related to mobile communications and, more particularly, to tracking lost devices with respect to user equipment and network apparatus in mobile communications.

### BACKGROUND

Unless otherwise indicated herein, approaches described in this section are not prior art to the claims listed below and are not admitted as prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals. In addition, there are some newly developed next generation communication technologies such as 5^{th} Generation (5G), New Radio (NR), Internet of Things (IoT) and Narrow Band Internet of Things (NB-IoT). These communication technologies are developed for higher speed transmission and serving for huge number of devices including machine type devices.

In some scenarios, the mobile terminal or the UE may be lost or stolen accidentally. The subscriber identification module (SIM) card of the lost device may be physically removed. Alternatively, the lost device may be in a limited service area without Internet access (e.g., Wi-Fi) available in the area. In such scenarios, it is hard to track the lost mobile device since there is no available service accessible for the lost device. In addition, in an event that the mobile device has been factory reset, the applications or operating system packages installed in the lost device may not be able to help track or recover the lost device. When the lost device is switched on without a SIM card, the lost device may camp in a limited service. Once the lost device is in the limited service, the network may have no idea where the lost device is. The lost device may be unable to be tracked at all.

Accordingly, it is important to track the lost device even when the lost device is in a limited service or has no available Internet access. Therefore, in developing communication systems, it is needed to provide proper mechanisms for tracking a lost device.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to tracking lost devices with respect to user equipment and network apparatus in mobile communications.

In one aspect, a method may involve an apparatus camping in a limited service. The method may also involve the apparatus transmitting a message to a network node to report an identity of the apparatus. The method may further involve the apparatus receiving a response message from the network node. The method may further involve the apparatus performing a location service (LCS) procedure initiated by the network node.

In one aspect, a method may involve a network node receiving a message with an identity of an apparatus. The method may also involve the network node determine whether the identity is in a blacklist. The method may further involve the network node transmitting a response message to the apparatus. The method may further involve the network node initiating a location service (LCS) procedure with the apparatus.

In one aspect, a method may involve an apparatus camping in a limited service. The method may also involve the apparatus receiving a broadcast message with a blacklist. The method may further involve the apparatus determining whether an identity of the apparatus is in the blacklist. The method may further involve the apparatus transmitting a message to a network node in an event that the identity is in the blacklist.

In one aspect, a method may involve a network node transmitting a broadcast message with a black list. The method may also involve the network node receiving a message from an apparatus. The method may further involve the network node initiating a location service (LCS) procedure with the apparatus. The message may indicate that an identity of the apparatus is in the blacklist.

It is noteworthy that, although description provided herein may be in the context of certain radio access technologies, networks and network topologies such as Global System for Mobile communications (GSM), Universal Mobile Telecommunications System (UMTS), Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIGS. 2A-2B are diagrams depicting some example message formats under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication apparatus and an example network apparatus in accordance with an implementation of the present disclosure.

FIG. 7 is a flowchart of an example process in accordance with an implementation of the present disclosure.

FIG. 8 is a flowchart of an example process in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to tracking lost devices with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In some scenarios, for example, a mobile device is lost or stolen. The subscriber identification module (SIM) card of the mobile device is physically removed. There is no Internet access (e.g., Wi-Fi) for the lost mobile device. Alternatively, a mobile device is lost or stolen. The SIM card of the mobile device is physically removed. There is Internet access for the lost mobile device, but the mobile device has been factory reset. Alternatively, a mobile device is lost or stolen. The lost mobile device is in a limited service area without Internet access available in the area. In the above scenarios, it is almost impossible to track the lost mobile device since there is no available Internet access for mobile device's connectivity. In addition, in an event that the mobile device has been factory reset, the applications or operating system packages installed in the mobile device may not be able to help track or recover the lost mobile device. When the mobile device is switched on without a SIM card, the mobile device may camp in a limited service. Once the mobile device is in the limited service, the network may have no idea where the mobile device is. The mobile device is almost unable to be tracked at all.

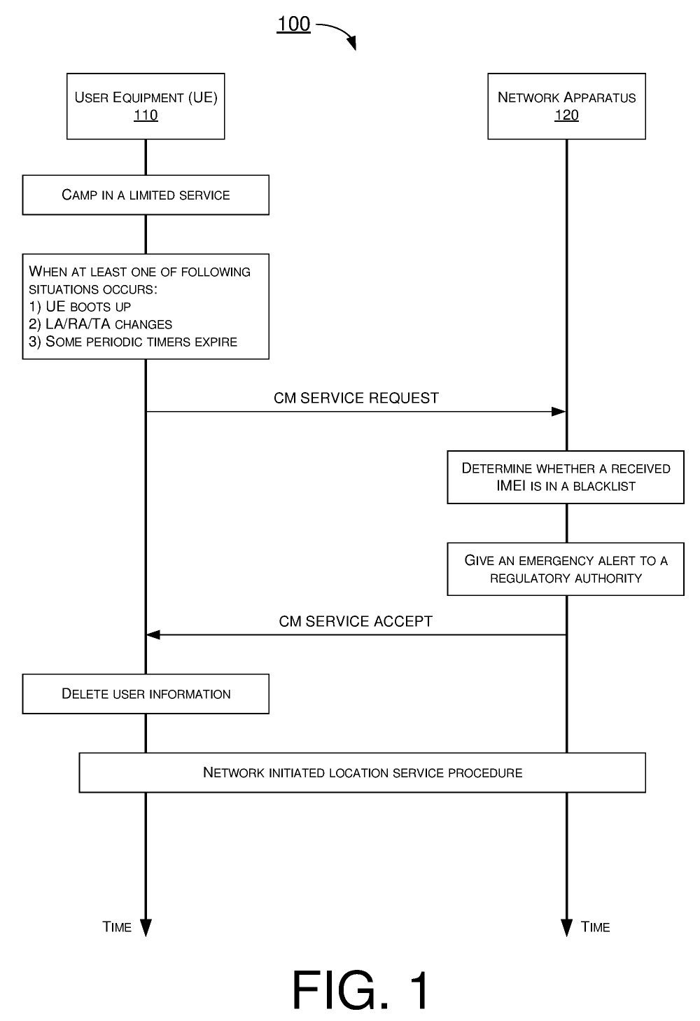

FIG. 1 illustrates an example scenario 100 under schemes in accordance with implementations of the present disclosure. Scenario 100 involves a user equipment (UE) 110 and a network apparatus 120, which may be a part of a wireless communication network (e.g., a Global System for Mobile communications (GSM) network, a Universal Mobile Telecommunications System (UMTS) network, a Long-Term Evolution (LTE) network, a 5^{th} Generation (5G) network, a New Radio (NR) network, an Internet of Things (IoT) network or a Narrow Band Internet of Things (NB-IoT) network). In scenario 100, UE 110 may camp in a limited service. For example, when UE 110 is switched on without a SIM card or when UE 110 camps on a public land mobile network (PLMN) not belong to a home PLMN, UE 110 may enter into a limited service state. When UE 110 is in the limited service, UE 110 may further determine whether at least one of a plurality of situations is occurred. The situations may comprise, for example, whether UE 110 is just booted up. The situations may comprise, for example, whether at least one of a location area (LA), a routing area (RA) or a tracking area (TA) where UE 110 camped on is changed. The situations may comprise, for example, whether some timers or periodic timers of UE 110 expire. The periodicity of the periodic timers may vary linearly or exponentially.

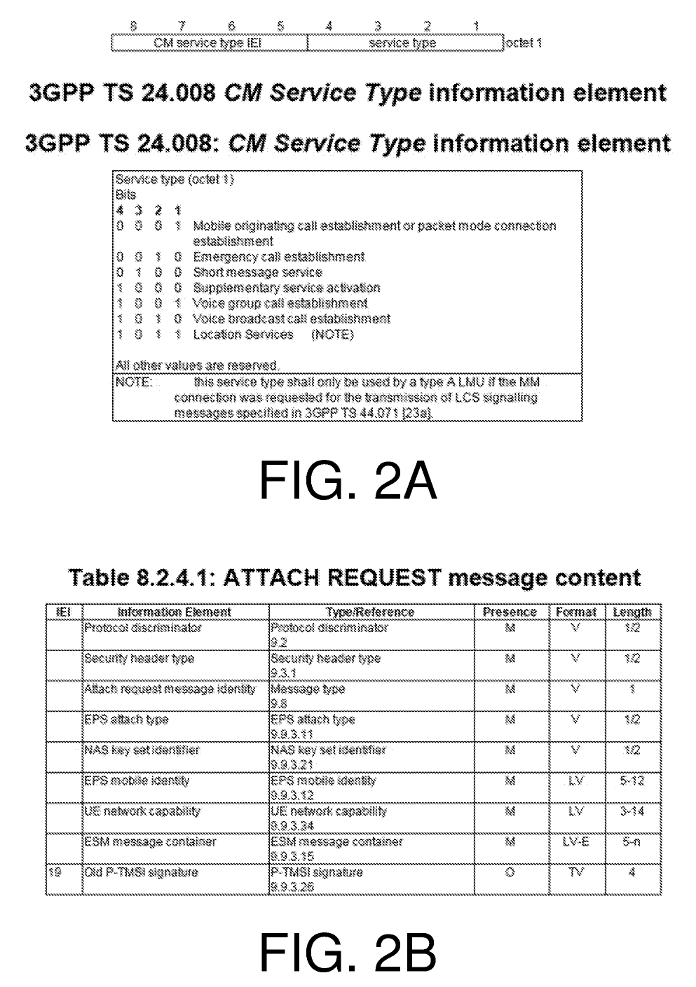

In an event that at least one of the situations is occurred while UE 110 camps in the limited service, UE 110 may be configured to transmit a message to network apparatus 120 for reporting an identity of UE 110. Specifically, the message may comprise, for example and without limitation, a connect management (CM) service request message. UE 110 may include its international mobile equipment identity (IMEI) in the CM service request message. The CM service request message may further comprise a CM service type information element. FIG. 2A illustrates an example message format of CM service type information element under schemes in accordance with implementations of the present disclosure. As showed in FIG. 2A, the CM service type information element may comprise 4 bits to represent or indicate different service type information. One of the reserved value of the CM service type may be used to carry or indicate the IMEI of UE 110. Alternatively, a new information element or a new message may also be defined or used to transmit the IMEI of UE 110 to network apparatus 120.

After receiving the message with the identity of UE 110 (e.g., CM service request message with CM service type set to IMEI), network apparatus 120 may be configured to determine whether the IMEI is in a blacklist. Specifically, network apparatus may maintain a blacklist to record a plurality of identities (e.g., IMEIs) corresponding to a plurality of lost devices. When a mobile device or a UE is lost or stolen, the identity of the UE may be reported to an operator. The operator may create a blacklist to record the identities of these lost UEs and store the blacklist in a plurality of network nodes (e.g., network apparatus 120). When the network node receiving the message with an identity, the network node may search the blacklist to determine whether the identity is matched with any identity in the blacklist. In an event that the received identity is in the blacklist, it means that the UE is a lost device. In an event that the received identity is not in the blacklist, it means that the UE is a normal device. The operator may keep updating the blacklist stored in the network nodes.

In an event that the IMEI sent from UE 110 is in the blacklist, network apparatus 120 may be configured to transmit a response message to UE 110. The response message may comprise a CM service accept message or a CM service success message. The response message may be used to inform UE 110 that it belongs to a lost device. Network apparatus 120 may further be configured to initiate a location service (LCS) procedure with UE 110 to retrieve the location information of UE 110. The LCS procedure may comprise, for example, a network initiated-mobile terminated location request (NI-MTLR). Accordingly, network apparatus 120 may be aware of the exact location of UE 110. Network apparatus 120 may further be configured to inform a regulatory authority about the detection of a lost device (e.g., UE 110). Specifically, network apparatus 120 may report the detection of the lost device to a back-end control center. The operator may further report the detection to the related regulatory authority (e.g., a police station). Network apparatus 120 may keep tracking the lost device and providing the location information of the lost device to the regulatory authority.

At the UE side, UE 110 may perform the LCS procedure initiated by network apparatus 120. UE 110 may be configured to provide its location information to network apparatus 120. After receiving the response message, UE 110 may be aware of that it belongs to a lost device, UE 110 may further be configured to delete all user information (e.g., personal information) to avoid information leakage. Furthermore, UE 110 may also be configured to raise an alert or any other warning activities after receiving the response message.

In some implementations, a network apparatus may not support this feature. For example, a network apparatus may not recognize or handle a CM service request message with an IMEI. The network apparatus may be configured to transmit a CM service reject message in response to the CM service request message with the IMEI. In this case, the UE may be configured to wait for next PLMN change to avoid unnecessary power consumption since the current network apparatus does not support this feature. Alternatively, the network apparatus may be configured to ignore the CM service request message with the IMEI and not to transmit any response message. In an event that the CM service request message with the IMEI is rejected by the same PLMN multiple times or is ignored for a period of time, the UE may be configured to stop transmitting the CM service request message and wait for next PLMN change. Ignoring or rejecting the CM service request message by the network apparatus may be considered as unable to support this feature.

In LTE, some other messages may be used to inform the network apparatus about the identity (e.g., IMEI) of the UE. For example, an attach request message may be used to carry the IMEI of the UE. FIG. 2B illustrates an example message format of attach request message under schemes in accordance with implementations of the present disclosure. As showed in FIG. 2B, the evolved packet system (EPS) attach type information element of the attach request message may be used to inform the network apparatus. Alternatively, a reserved information element/value or a new information element/value may be used to inform the network apparatus or carry the IMEI of the UE.

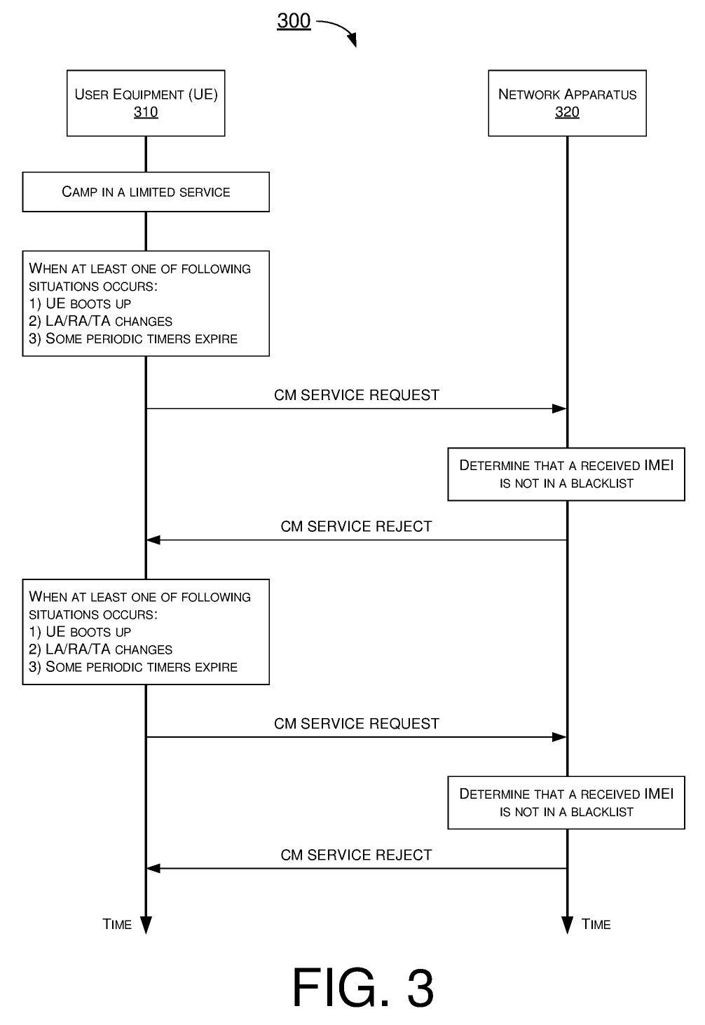

FIG. 3 illustrates an example scenario 300 under schemes in accordance with implementations of the present disclosure. Scenario 300 involves a UE 310 and a network apparatus 320, which may be a part of a wireless communication network (e.g., a Global System for Mobile communications (GSM) network, a Universal Mobile Telecommunications System (UMTS) network, a Long-Term Evolution (LTE) network, a 5^{th} Generation (5G) network, a New Radio (NR) network, an Internet of Things (IoT) network or a Narrow Band Internet of Things (NB-IoT) network). Similarly, UE 310 may camp in a limited service. When UE 310 is in the limited service, UE 310 may further determine whether at least one of a plurality of situations is occurred. The situations may comprise, for example, whether UE 310 is just booted up, whether at least one of a LA, a RA or a TA of UE 310 is changed, or whether some timers of UE 310 expire.

In an event that at least one of the situations is occurred while UE 310 is camping in the limited service, UE 310 may be configured to transmit a message (e.g., a CM service request message or an attach request message) to network apparatus 320 for reporting an identity (e.g., IMEI) of UE 310. After receiving the message with the IMEI of UE 310, network apparatus 320 may be configured to determine whether the IMEI is in a blacklist. Network apparatus 320 may search the blacklist to determine whether the IMEI of UE 310 is matched with any IMEI in the blacklist. In an event that the IMEI sent from UE 310 is not in the blacklist, network apparatus 320 may be configured to transmit a response message to UE 310. The response message may comprise a reject message, a CM service reject message or an attach reject message. The response message may be used to inform UE 310 that it belongs to a normal device.

After receiving the response message, UE 310 may act as a normal device camped in the limited service. UE 310 may be configured to keep monitoring whether at least one of the plurality of situations is occurred while in the limited service state. In an event that at least one of the situations is occurred, UE 310 may further be configured to transmit the message with IMEI (e.g., a CM service request message or an attach request message) again to network apparatus 320. Accordingly, whenever receiving the message with IEMI from UE 310, network apparatus 320 may be able to determine whether UE 310 is lost or stolen.

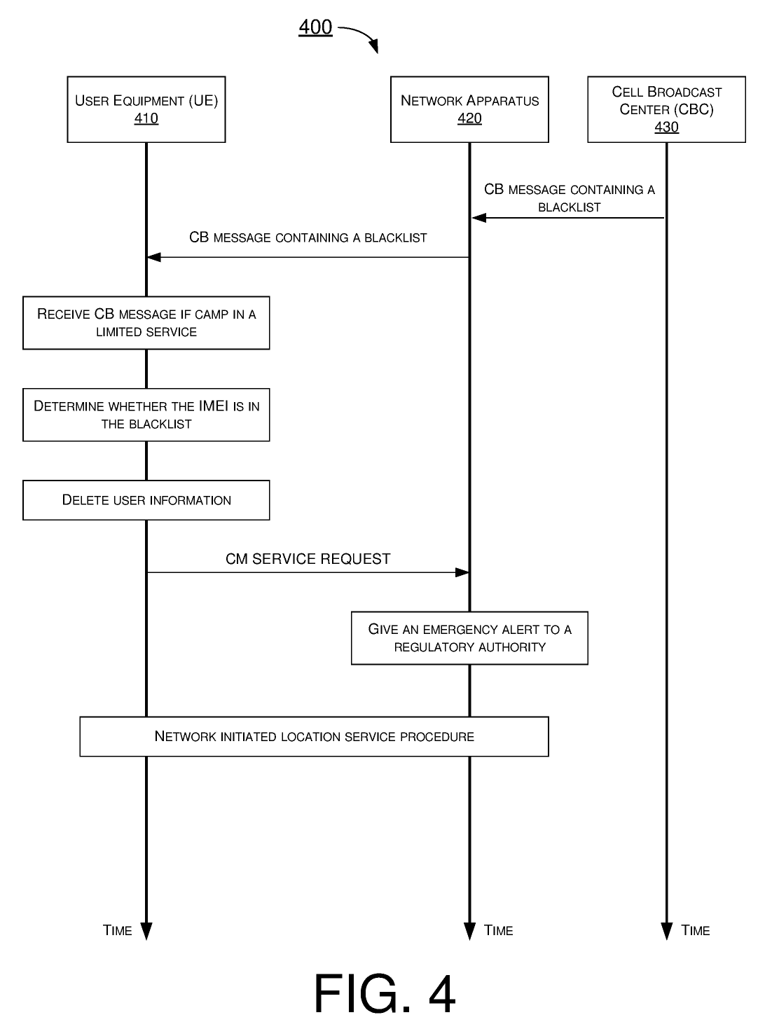

FIG. 4 illustrates an example scenario 400 under schemes in accordance with implementations of the present disclosure. Scenario 400 involves a user equipment (UE) 410, a network apparatus 420 and a cell broadcast center (CBC) 430, which may be a part of a wireless communication network (e.g., a Global System for Mobile communications (GSM) network, a Universal Mobile Telecommunications System (UMTS) network, a Long-Term Evolution (LTE) network, a 5^{th} Generation (5G) network, a New Radio (NR) network, an Internet of Things (IoT) network or a Narrow Band Internet of Things (NB-IoT) network). CBC 430 may be configured to transmit a cell broadcast (CB) message to network apparatus 420. The cell broadcast message may comprise a blacklist. The blacklist may comprise information (e.g., IMEIs) corresponding to a plurality of lost devices. After receiving the cell broadcast message, network apparatus 420 may be configured to transmit the cell broadcast message to UE 410. CBC 430 may periodically transmit the cell broadcast message to a plurality of network apparatus (e.g., network apparatus 420). Network apparatus 420 may periodically broadcast the cell broadcast message to a plurality UEs (e.g., UE 410).

UE 410 may be configured to receive the cell broadcast message in an event that UE 410 camps in a limited service. After receiving the cell broadcast message, UE 410 may be configured to determine whether the identity (e.g., IMEI) of UE 410 is in the blacklist. Specifically, UE 410 may search the received blacklist to determine whether the identity of UE 410 is matched with any identity in the blacklist. In an event that the identity is in the received blacklist, it means that UE 410 is a lost device. In an event that the received identity is not in the received blacklist, it means that UE 410 is a normal device. UE 410 may periodically receive the cell broadcast message to update the blacklist.

In an event that the IMEI of UE 410 is in the blacklist, UE 410 may be configured to transmit a message to network apparatus 420. The message may comprise a CM service request message or an attach request message. The message may be used to inform network apparatus 420 that UE 410 belongs to a lost device. Then, UE 410 may perform a LCS procedure initiated by network apparatus 420. UE 410 may be configured to provide its location information to network apparatus 420. Since UE 410 is aware of that it belongs to a lost device, UE 410 may further be configured to delete all user information (e.g., personal information) to avoid information leakage. Furthermore, UE 410 may also be configured to raise an alert or any other warning activities after receiving the response message.

At the network side, after receiving the message (e.g., a CM service request message or an attach request message) from UE 410, network apparatus 420 may be configured to initiate a LCS procedure with UE 410 to retrieve the location information of UE 410. The LCS procedure may comprise, for example, a network initiated-mobile terminated location request (NI-MTLR). Accordingly, network apparatus 420 may be aware of the exact location of UE 410. Network apparatus 420 may further be configured to inform a regulatory authority about the detection of a lost device (e.g., UE 410). Specifically, network apparatus 420 may report the detection of the lost device to a back-end control center. The operator may further report the detection to the related regulatory authority (e.g., a police station). Network apparatus 420 may keep tracking the lost device and providing the location information of the lost device to the regulatory authority.

In an event that the IMEI of UE 410 is not in the blacklist, UE 410 may determine that it belong to a normal device. UE 410 may be configured to ignore or discard the cell broadcast message. UE 410 may wait for a next cell broadcast message to check whether its identity is in an updated blacklist.

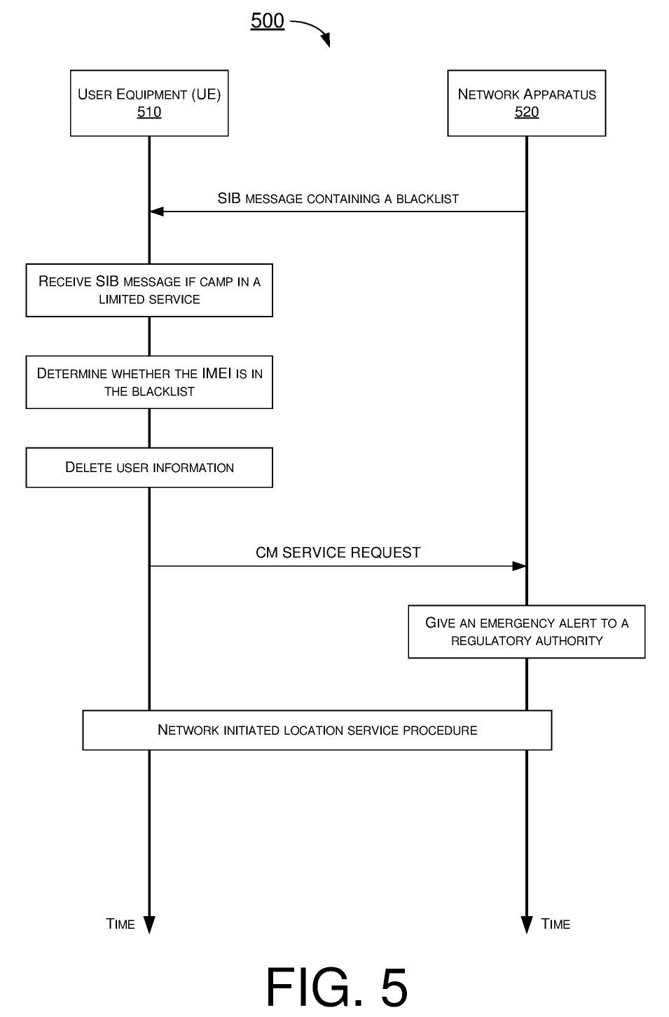

FIG. 5 illustrates an example scenario 500 under schemes in accordance with implementations of the present disclosure. Scenario 500 involves a user equipment (UE) 510 and a network apparatus 520, which may be a part of a wireless communication network (e.g., a Global System for Mobile communications (GSM) network, a Universal Mobile Telecommunications System (UMTS) network, a Long-Term Evolution (LTE) network, a 5^{th} Generation (5G) network, a New Radio (NR) network, an Internet of Things (IoT) network or a Narrow Band Internet of Things (NB-IoT) network). Network apparatus 520 may be configured to transmit a system information block (SIB) message to UE 510. The SIB message may comprise a blacklist. The blacklist may comprise information (e.g., IMEIs) corresponding to a plurality of lost devices. Network apparatus 520 may periodically broadcast the SIB message to a plurality UEs (e.g., UE 510).

UE 510 may be configured to receive the SIB message in an event that UE 510 camps in a limited service. After receiving the SIB message, UE 510 may be configured to determine whether the identity (e.g., IMEI) of UE 510 is in the blacklist. Specifically, UE 510 may search the received blacklist to determine whether the identity of UE 510 is matched with any identity in the blacklist. In an event that the identity is in the received blacklist, it means that UE 510 is a lost device. In an event that the received identity is not in the received blacklist, it means that UE 510 is a normal device. UE 510 may periodically receive the SIB message to update the blacklist.

In an event that the IMEI of UE 510 is in the blacklist, UE 510 may be configured to transmit a message to network apparatus 520. The message may comprise a CM service request message or an attach request message. The message may be used to inform network apparatus 520 that UE 510 belongs to a lost device. Then, UE 510 may perform a LCS procedure initiated by network apparatus 520. UE 510 may be configured to provide its location information to network apparatus 520. Since UE 510 is aware of that it belongs to a lost device, UE 510 may further be configured to delete all user information (e.g., personal information) to avoid information leakage. Furthermore, UE 510 may also be configured to raise an alert or any other warning activities after receiving the response message.

At the network side, after receiving the message (e.g., a CM service request message or an attach request message) from UE 510, network apparatus 520 may be configured to initiate a LCS procedure with UE 510 to retrieve the location information of UE 510. The LCS procedure may comprise, for example, a network initiated-mobile terminated location request (NI-MTLR). Accordingly, network apparatus 520 may be aware of the exact location of UE 510. Network apparatus 520 may further be configured to inform a regulatory authority about the detection of a lost device (e.g., UE 510). Specifically, network apparatus 520 may report the detection of the lost device to a back-end control center. The operator may further report the detection to the related regulatory authority (e.g., a police station). Network apparatus 520 may keep tracking the lost device and providing the location information of the lost device to the regulatory authority.

In an event that the IMEI of UE 510 is not in the blacklist, UE 510 may determine that it belong to a normal device. UE 510 may be configured to ignore or discard the SIB message. UE 510 may wait for a next SIB message to check whether its identity is in an updated blacklist.

### Illustrative Implementations

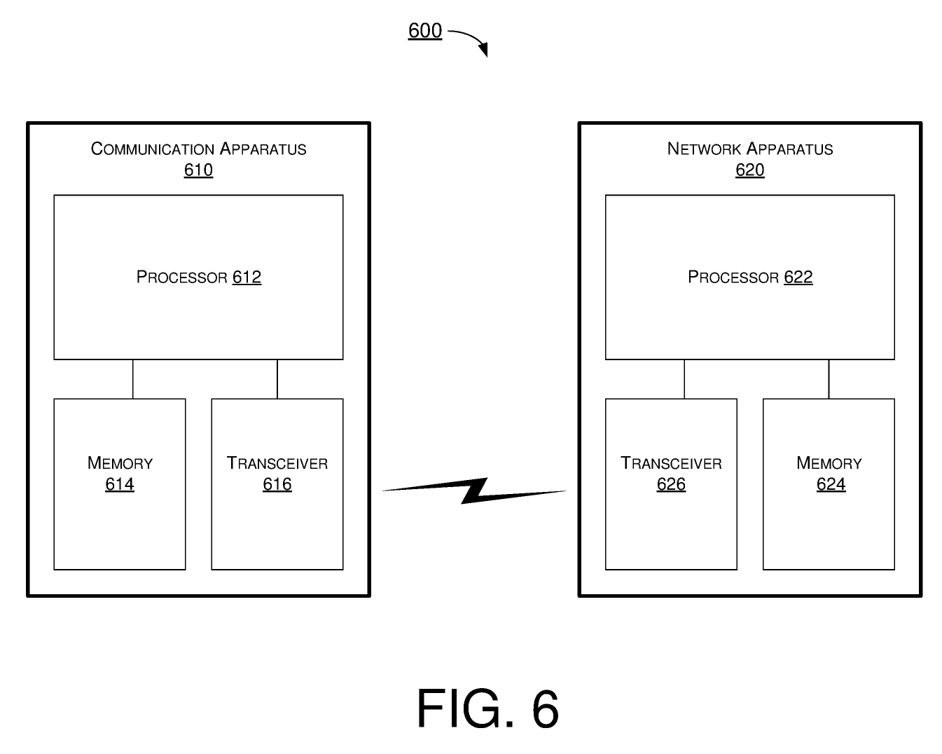

FIG. 6 illustrates an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to tracking lost devices with respect to user equipment and network apparatus in wireless communications, including scenarios 100, 300, 400 and 500 described above as well as processes 700, 800, 900 and 1000 described below.

Communication apparatus 610 may be a part of an electronic apparatus, which may be a user equipment (UE) such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT or NB-IoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, or one or more complex-instruction-set-computing (CISC) processors. Communication apparatus 610 may include at least some of those components shown in FIG. 6 such as a processor 612, for example. communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a base station, a small cell, a router or a gateway. For instance, network apparatus 620 may be implemented in a base station in a GSM or UMTS network, in an eNodeB in a LTE, LTE-Advanced or LTE-Advanced Pro network, or in a gNB in a 5G, NR, IoT or NB-IoT network. Alternatively, network apparatus 620 may be implemented in the form of one or more IC chips such as, for example and without limitation, one or more single-core processors, one or more multi-core processors, or one or more CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including power consumption reduction in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, processor 612 may camp in a limited service. For example, when communication apparatus 610 is switched on without a SIM card or when processor 612 camps on a public land mobile network (PLMN) not belong to a home PLMN, processor 612 may enter into a limited service state. When communication apparatus 610 is in the limited service, processor 612 may further determine whether at least one of a plurality of situations is occurred. The situations may comprise, for example, whether communication apparatus 610 is just booted up. The situations may comprise, for example, whether at least one of a location area (LA), a routing area (RA) or a tracking area (TA) where processor 612 camped on is changed. The situations may comprise, for example, whether some timers or periodic timers of processor 612 expire. The periodicity of the periodic timers may vary linearly or exponentially.

In some implementations, at least one of the situations may occur while processor 612 camps in the limited service, processor 612 may be configured to transmit a message to network apparatus 620 for reporting an identity of communication apparatus 610. Specifically, the message may comprise, for example and without limitation, a connect management (CM) service request message. Processor 612 may include its international mobile equipment identity (IMEI) in the CM service request message. The CM service request message may further comprise a CM service type information element. Processor 612 may use the CM service type information element to represent or indicate different service type information. Processor 612 may one of the reserved value of the CM service type to carry or indicate the IMEI of communication apparatus 610. Alternatively, processor 612 may use a new information element or a new message to transmit the IMEI of communication apparatus 610 to network apparatus 620.

In some implementations, after receiving the message with the identity of communication apparatus (e.g., CM service request message with CM service type set to IMEI), processor 622 may be configured to determine whether the IMEI is in a blacklist. Specifically, network apparatus 620 may maintain a blacklist in memory 624 to record a plurality of identities (e.g., IMEIs) corresponding to a plurality of lost devices. When a communication apparatus is lost or stolen, the identity of the communication apparatus may be reported to an operator. The operator may create a blacklist to record the identities of these lost communication apparatus and store the blacklist in a plurality of network nodes (e.g., network apparatus 620). When the network apparatus receiving the message with an identity, the network apparatus may search the blacklist to determine whether the identity is matched with any identity in the blacklist. In an event that the received identity is in the blacklist, it means that the communication apparatus is a lost device. In an event that the received identity is not in the blacklist, it means that the communication apparatus is a normal device. The operator may keep updating the blacklist stored in the network apparatus.

In some implementations, in an event that the IMEI sent from communication apparatus 610 is in the blacklist, processor 622 may be configured to transmit a response message to communication apparatus 610. The response message may comprise a CM service accept message or a CM service success message. Processor 622 may use the response message to inform communication apparatus 610 that it belongs to a lost device. Processor 622 may further be configured to initiate a location service (LCS) procedure with communication apparatus 610 to retrieve the location information of communication apparatus 610. The LCS procedure may comprise, for example, a network initiated-mobile terminated location request (NI-MTLR). Accordingly, processor 622 may be aware of the exact location of communication apparatus 610. Processor 622 may further be configured to inform a regulatory authority about the detection of a lost device (e.g., communication apparatus 610). Specifically, processor 622 may report the detection of the lost device to a back-end control center. The operator may further report the detection to the related regulatory authority (e.g., a police station). Processor 622 may keep tracking the lost device and providing the location information of the lost device to the regulatory authority.

In some implementations, processor 612 may be configured to perform the LCS procedure initiated by network apparatus 620. Processor 612 may be configured to provide its location information to network apparatus 620. After receiving the response message, processor 612 may be aware of that it belongs to a lost device, processor 612 may further be configured to delete all user information (e.g., personal information) to avoid information leakage. Furthermore, processor 612 may also be configured to raise an alert or any other warning activities after receiving the response message.

In some implementations, a network apparatus may not support this feature. For example, a network apparatus may not recognize or handle a CM service request message with an IMEI. The network apparatus may be configured to transmit a CM service reject message in response to the CM service request message with the IMEI. In this case, the communication apparatus may be configured to wait for next PLMN change to avoid unnecessary power consumption since the current network apparatus does not support this feature. Alternatively, the network apparatus may be configured to ignore the CM service request message with the IMEI and not to transmit any response message. In an event that the CM service request message with the IMEI is rejected by the same PLMN multiple times or is ignored for a period of time, the communication apparatus may be configured to stop transmitting the CM service request message and wait for next PLMN change. Ignoring or rejecting the CM service request message by the network apparatus may be considered as unable to support this feature.

In some implementations, some other messages in LTE may be used to inform the network apparatus about the identity (e.g., IMEI) of the communication apparatus. For example, processor 612 may use an attach request message to carry the IMEI of communication apparatus 610. Processor 612 may use the evolved packet system (EPS) attach type information element of the attach request message to inform network apparatus 620. Alternatively, processor 612 may use a reserved information element/value or a new information element/value to inform network apparatus 620 or carry the IMEI of communication apparatus 610.

In some implementations, after receiving the message with the IMEI of communication apparatus 610, processor 622 may be configured to determine whether the IMEI is in a blacklist. Processor 622 may search the blacklist to determine whether the IMEI of communication apparatus 610 is matched with any IMEI in the blacklist. In an event that the IMEI sent from communication apparatus 610 is not in the blacklist, processor 622 may be configured to transmit a response message to communication apparatus 610. The response message may comprise a reject message, a CM service reject message or an attach reject message. Processor 622 may use the response message to inform communication apparatus 610 that it belongs to a normal device.

In some implementations, after receiving the response message, processor 612 may act as a normal device camped in the limited service. Processor 612 may be configured to keep monitoring whether at least one of the plurality of situations is occurred while in the limited service state. In an event that at least one of the situations is occurred, processor 612 may further be configured to transmit the message with IMEI (e.g., a CM service request message or an attach request message) again to network apparatus 620. Accordingly, whenever receiving the message with IEMI from communication apparatus 610, network apparatus 620 may be able to determine whether communication apparatus 610 is lost or stolen.

In some implementations, processor 622 may be configured to transmit a cell broadcast message to communication apparatus 610. The cell broadcast message may comprise a blacklist. The blacklist may comprise information (e.g., IMEIs) corresponding to a plurality of lost devices. Processor 622 may periodically broadcast the cell broadcast message to a plurality UEs (e.g., communication apparatus 610).

In some implementations, processor 612 may be configured to receive the cell broadcast message in an event that processor 612 camps in a limited service. After receiving the cell broadcast message, processor 612 may be configured to determine whether the identity (e.g., IMEI) of communication apparatus 610 is in the blacklist. Specifically, processor 612 may search the received blacklist to determine whether the identity of communication apparatus 610 is matched with any identity in the blacklist. In an event that the identity is in the received blacklist, it means that communication apparatus 610 is a lost device. In an event that the received identity is not in the received blacklist, it means that communication apparatus 610 is a normal device. Processor 612 may periodically receive the cell broadcast message to update the blacklist.

In some implementations, when the IMEI of communication apparatus 610 is in the blacklist, processor 612 may be configured to transmit a message to network apparatus 620. The message may comprise a CM service request message or an attach request message. Processor 612 may use the message may to inform network apparatus 620 that communication apparatus 610 belongs to a lost device. Then, processor 612 may perform a LCS procedure initiated by network apparatus 620. Processor 612 may be configured to provide its location information to network apparatus 620. Since processor 612 is aware of that it belongs to a lost device, processor 612 may further be configured to delete all user information (e.g., personal information) to avoid information leakage. Furthermore, processor 612 may also be configured to raise an alert or any other warning activities after receiving the response message.

In some implementations, after receiving the message (e.g., a CM service request message or an attach request message) from communication apparatus 610, processor 622 may be configured to initiate a LCS procedure with communication apparatus 610 to retrieve the location information of communication apparatus 610. The LCS procedure may comprise, for example, a network initiated-mobile terminated location request (NI-MTLR). Accordingly, processor 622 may be aware of the exact location of communication apparatus 610. Processor 622 may further be configured to inform a regulatory authority about the detection of a lost device (e.g., communication apparatus 610). Specifically, processor 622 may report the detection of the lost device to a back-end control center. The operator may further report the detection to the related regulatory authority (e.g., a police station). Processor 622 may keep tracking the lost device and providing the location information of the lost device to the regulatory authority.

In some implementations, when the IMEI of communication apparatus 610 is not in the blacklist, processor 612 may determine that it belong to a normal device. Processor 612 may be configured to ignore or discard the cell broadcast message. Processor 612 may wait for a next cell broadcast message to check whether its identity is in an updated blacklist.

In some implementations, processor 622 may be configured to transmit a system information block (SIB) message to communication apparatus 610. The SIB message may comprise a blacklist. The blacklist may comprise information (e.g., IMEIs) corresponding to a plurality of lost devices. Processor 622 may periodically broadcast the SIB message to a plurality UEs (e.g., UE 510).

In some implementations, processor 612 may be configured to receive the SIB message in an event that processor 612 camps in a limited service. After receiving the SIB message, processor 612 may be configured to determine whether the identity (e.g., IMEI) of communication apparatus 610 is in the blacklist. Specifically, processor 612 may search the received blacklist to determine whether the identity of communication apparatus 610 is matched with any identity in the blacklist. In an event that the identity is in the received blacklist, it means that communication apparatus 610 is a lost device. In an event that the received identity is not in the received blacklist, it means that communication apparatus 610 is a normal device. Processor 612 may periodically receive the SIB message to update the blacklist.

In some implementations, when the IMEI of communication apparatus 610 is not in the blacklist, processor 612 may determine that it belong to a normal device. Processor 612 may be configured to ignore or discard the SIB message. Processor 612 may wait for a next SIB message to check whether its identity is in an updated blacklist.

### Illustrative Processes

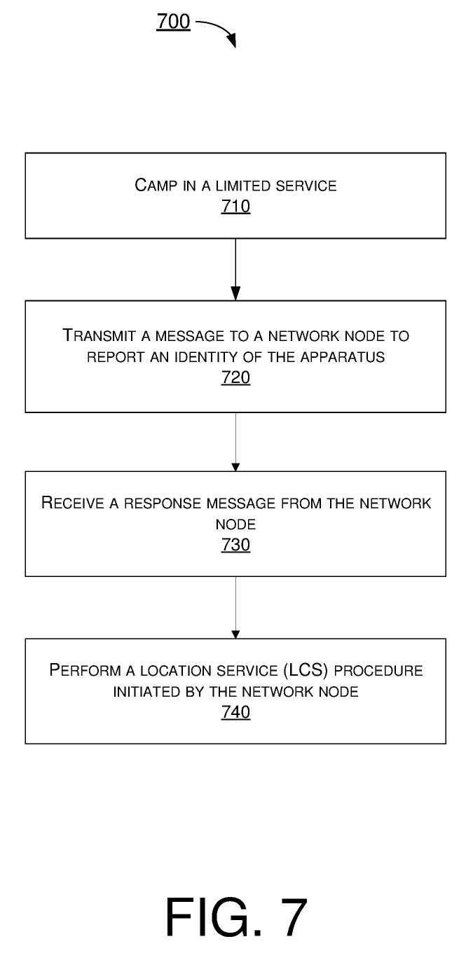

FIG. 7 illustrates an example process 700 in accordance with an implementation of the present disclosure. Process 700 may be an example implementation of scenario 100, whether partially or completely, with respect to tracking lost devices in accordance with the present disclosure. Process 700 may represent an aspect of implementation of features of communication apparatus 610. Process 700 may include one or more operations, actions, or functions as illustrated by one or more of blocks 710, 720, 730 and 740. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve communication apparatus 610 camping in a limited service. Process 700 may proceed from 710 to 720.

At 720, process 700 may involve communication apparatus 610 transmitting a message to a network node to report an identity of the apparatus. Process 700 may proceed from 720 to 730.

At 730, process 700 may involve communication apparatus 610 receiving a response message from the network node. Process 700 may proceed from 730 to 740.

At 740, process 700 may involve communication apparatus 610 performing a location service (LCS) procedure initiated by the network node.

In some implementations, the message may comprise a connect management (CM) service request message or an attach request message. Process 700 may involve communication apparatus 610 transmitting the message periodically, after the apparatus boots up, or when at least one of a location area (LA), a routing area (RA) or a tracking area (TA) is changed.

In some implementations, process 700 may involve communication apparatus 610 deleting user information after receiving the response message when the response message indicates that the identity is in a blacklist.

In some implementations, process 700 may involve communication apparatus 610 raising an alert after receiving the response message when the response message indicates that the identity is in a blacklist.

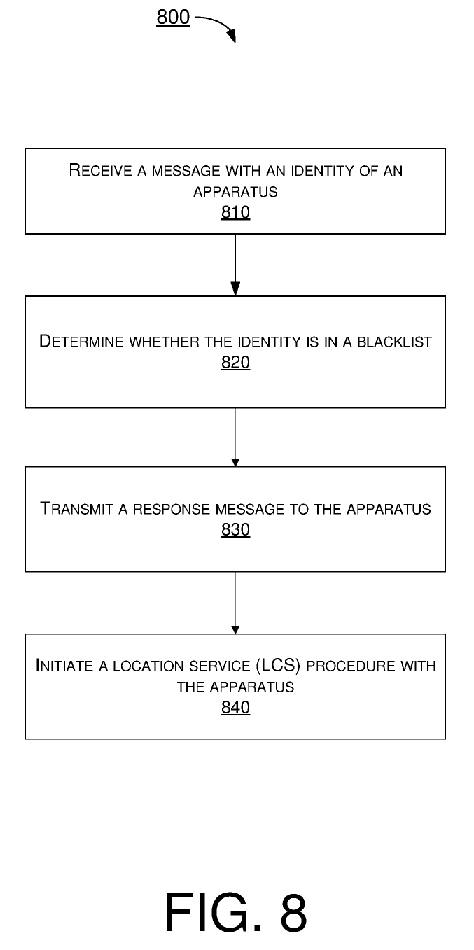

FIG. 8 illustrates an example process 800 in accordance with an implementation of the present disclosure. Process 800 may be an example implementation of scenario 100, whether partially or completely, with respect to tracking lost devices in accordance with the present disclosure. Process 800 may represent an aspect of implementation of features of network apparatus 620. Process 800 may include one or more operations, actions, or functions as illustrated by one or more of blocks 810, 820, 830 and 840. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may be implemented by network apparatus 620 or any suitable base stations or network nodes. Solely for illustrative purposes and without limitation, process 800 is described below in the context of network apparatus 620. Process 800 may begin at block 810.

At 810, process 800 may involve network apparatus 620 receiving a message with an identity of an apparatus. Process 800 may proceed from 810 to 820.

At 820, process 800 may involve network apparatus 620 determine whether the identity is in a blacklist. Process 800 may proceed from 820 to 830.

At 830, process 800 may involve network apparatus 620 transmitting a response message to the apparatus. Process 800 may proceed from 830 to 840.

At 840, process 800 may involve network apparatus 620 initiating a location service (LCS) procedure with the apparatus.

In some implementations, the message may comprise a connect management (CM) service request message or an attach request message. The response message may comprise a reject message in an event that the identity is not in the blacklist.

In some implementations, process 800 may involve network apparatus 620 retrieving location information of the apparatus in the LCS procedure.

In some implementations, process 800 may involve network apparatus 620 informing a regulatory authority in an event that the identity is in the blacklist.

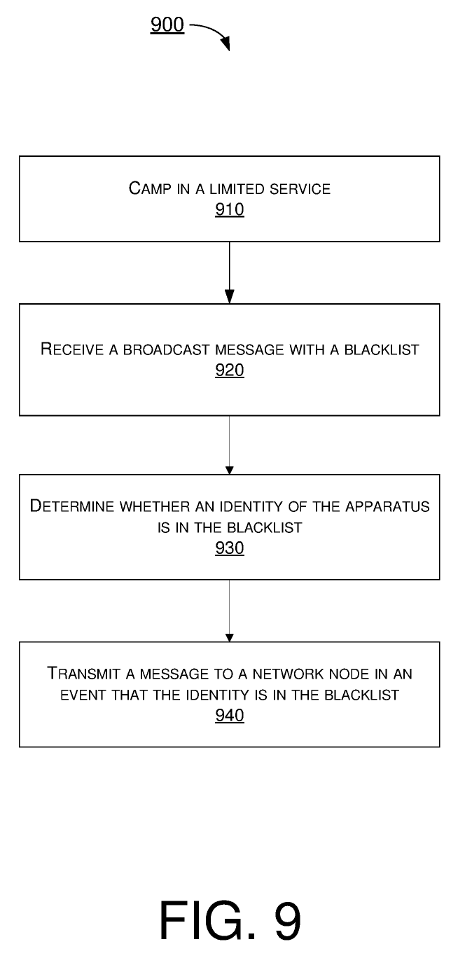

FIG. 9 illustrates an example process 900 in accordance with an implementation of the present disclosure. Process 900 may be an example implementation of scenarios 400 and 500, whether partially or completely, with respect to tracking lost devices in accordance with the present disclosure. Process 900 may represent an aspect of implementation of features of communication apparatus 610. Process 900 may include one or more operations, actions, or functions as illustrated by one or more of blocks 910, 920, 930 and 940. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may be implemented by communication apparatus 610 or any suitable UE or machine type devices. Solely for illustrative purposes and without limitation, process 900 is described below in the context of communication apparatus 610. Process 900 may begin at block 910.

At 910, process 900 may involve communication apparatus 610 camping in a limited service. Process 900 may proceed from 910 to 920.

At 920, process 900 may involve communication apparatus 610 receiving a broadcast message with a blacklist. Process 900 may proceed from 920 to 930.

At 930, process 900 may involve communication apparatus 610 determining whether an identity of the apparatus is in the blacklist. Process 900 may proceed from 930 to 940.

At 940, process 900 may involve communication apparatus 610 transmitting a message to a network node in an event that the identity is in the blacklist.

In some implementations, process 900 may involve communication apparatus 610 deleting user information in an event that the identity is in the blacklist.

In some implementations, process 900 may involve communication apparatus 610 raising an alert in an event that the identity is in the blacklist.

In some implementations, process 900 may involve communication apparatus 610 performing a location service (LCS) procedure initiated by the network node.

In some implementations, the broadcast message may comprise a cell broadcast (CB) message or a system information block (SIB) message.

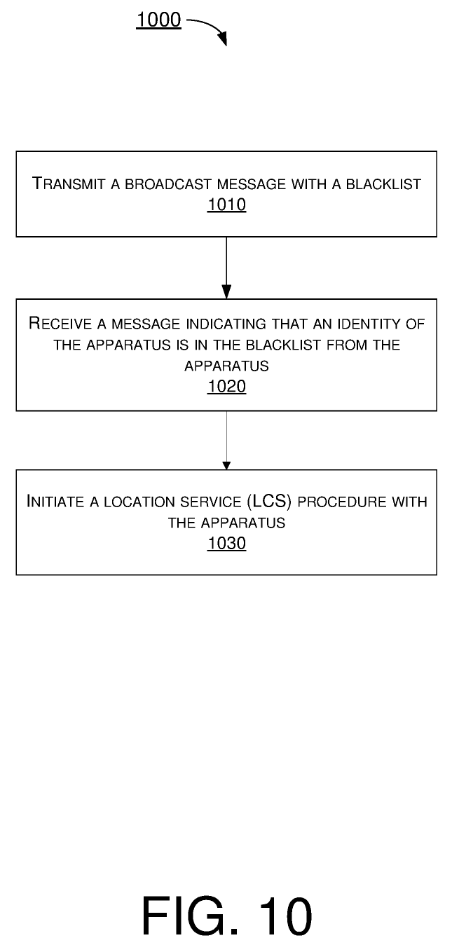

FIG. 10 illustrates an example process 1000 in accordance with an implementation of the present disclosure. Process 1000 may be an example implementation of scenarios 400 and 500, whether partially or completely, with respect to tracking lost devices in accordance with the present disclosure. Process 1000 may represent an aspect of implementation of features of network apparatus 620. Process 1000 may include one or more operations, actions, or functions as illustrated by one or more of blocks 1010, 1020 and 1030. Although illustrated as discrete blocks, various blocks of process 1000 may be divided into additional blocks, combined into fewer blocks, or eliminated, depending on the desired implementation. Moreover, the blocks of process 1000 may executed in the order shown in FIG. 10 or, alternatively, in a different order. Process 1000 may be implemented by network apparatus 620 or any suitable base stations or network nodes. Solely for illustrative purposes and without limitation, process 1000 is described below in the context of network apparatus 620. Process 1000 may begin at block 1010.

At 1010, process 1000 may involve network apparatus 620 transmitting a broadcast message with a black list. Process 1000 may proceed from 1010 to 1020.

At 1020, process 1000 may involve network apparatus 620 receiving a message indicating that an identity of the apparatus is in the blacklist from the apparatus. Process 1000 may proceed from 1020 to 1030.

At 1030, process 1000 may involve network apparatus 620 initiating a location service (LCS) procedure with the apparatus.

In some implementations, the message may comprise a connect management (CM) service request message or an attach request message. The broadcast message may comprise a cell broadcast (CB) message or a system information block (SIB) message.

In some implementations, process 1000 may involve network apparatus 620 retrieving location information of the apparatus in the LCS procedure.

In some implementations, process 1000 may involve network apparatus 620 informing a regulatory authority in response to receiving of the message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method of communication network, comprising:
camping, by a processor of an apparatus, in a limited service state, in response to the apparatus switching on without a subscriber identification module (SIM) card or the apparatus camping on, which does not belong to a home public land mobile network (PLMN);
transmitting, by the processor, a message to a network node to report an identity of the apparatus;
receiving, by the processor, a response message from the network node; and
performing, by the processor, a location service (LCS) procedure initiated by the network node.

2. The method of claim 1, wherein the message comprises a connect management (CM) service request message or an attach request message.

3. The method of claim 1, wherein the transmitting comprises transmitting the message periodically, after the apparatus boots up, or when at least one of a location area (LA), a routing area (RA) or a tracking area (TA) is changed.

4. The method of claim 1, further comprising:
deleting, by the processor, user information after receiving the response message,
wherein the response message indicates that the identity is in a blacklist.

5. The method of claim 1, further comprising:
raising, by the processor, an alert after receiving the response message,
wherein the response message indicates that the identity is in a blacklist.

6. A method of communication network, comprising:
receiving, by a processor of a network node, a message with an identity of an apparatus which is camped on a limited service state, in response to the apparatus switching on without a subscriber identification module (SIM) card or the apparatus camping on, which does not belong to a home public land mobile network (PLMN);
determine, by the processor, whether the identity is in a blacklist;
transmitting, by the processor, a response message to the apparatus; and
initiating, by the processor, a location service (LCS) procedure with the apparatus.

7. The method of claim 6, wherein the message comprises a connect management (CM) service request message or an attach request message.

8. The method of claim 6, further comprising:
retrieving, by the processor, location information of the apparatus in the location service (LCS) LOS-procedure.

9. The method of claim 6, further comprising:
informing, by the processor, a regulatory authority in an event that the identity is in the blacklist.

10. The method of claim 6, wherein the response message comprises a reject message in an event that the identity is not in the blacklist.

11. A method of communication network, comprising:
camping, by a processor of an apparatus, in a limited service state, in response to the apparatus switching on without a subscriber identification module (SIM) card or the apparatus camping on, which does not belong to a home public land mobile network (PLMN);
receiving, by the processor, a broadcast message with a blacklist;
determining, by the processor, whether an identity of the apparatus is in the blacklist; and
transmitting, by the processor, a message to a network node in an event that the identity is in the blacklist.

12. The method of claim 11, further comprising:
deleting, by the processor, user information in an event that the identity is in the blacklist.

13. The method of claim 11, further comprising:
raising, by the processor, an alert in an event that the identity is in the blacklist.

14. The method of claim 11, further comprising:
performing, by the processor, a location service (LCS) procedure initiated by the network node.

15. The method of claim 1, wherein the broadcast message comprises a cell broadcast (CB) message or a system information block (SIB) message.

16. A method of communication network, comprising:
transmitting, by a processor of a network node, a broadcast message with a black list;
receiving, by the processor, a message from an apparatus which is camped on a limited service state, in response to the apparatus switching on without a subscriber identification module (SIM) card or the apparatus camping on, which does not belong to a home public land mobile network (PLMN); and
initiating, by the processor, a location service (LCS) procedure with the apparatus,
wherein the message indicates that an identity of the apparatus is in the blacklist.

17. The method of claim 16, wherein the message comprises a connect management (CM) service request message or an attach request message.

18. The method of claim 16, further comprising:
retrieving, by the processor, location information of the apparatus in the location service (LCS) LOS-procedure.

19. The method of claim 16, further comprising:
informing, by the processor, a regulatory authority in response to receiving of the message.

20. The method of claim 16, wherein the broadcast message comprises a cell broadcast (CB) message or a system information block (SIB) message.
